(19) United States
(12) Patent Application Publication
(10) Pub. No.: US 2019/0048658 A1
(43) Pub. Date: Feb. 14, 2019

(54) CONSTRUCTION ASSEMBLY FOR INSTALLING A ROLLER BLIND OR THE LIKE

(71) Applicant: Professional Blinds System Inc., Miami, FL (US)

(72) Inventor: Eduardo Alberto GARCIA HERNANDEZ, Miami, FL (US)

(21) Appl. No.: 15/672,358

(22) Filed: Aug. 9, 2017

(51) Int. Cl. E06B 9/44; E06B 9/58; E06B 9/90

(52) U.S. Cl. CPC E06B 9/44; E06B 2009/405; E06B 9/90; E06B 9/58

(57) ABSTRACT

A construction assembly for installing a roller blind or the like comprising two parallel guiding sets spaced at a predetermined distance, between which at the least a roller blind can be slid in a guided manner, the at the least roller blind being arranged in the upper part of the two guiding sets.

This construction assembly comprises an internally hollow outer profile that can be fastened to a vertical surface, an internally hollow inner profile that is arranged in the interior of the outer profile, the inner profile having dimensions such that it is insertable into a housing defined by the outer profile by means of a snap fit, and a retaining element configured to retain a longitudinal edge of the roller blind arranged longitudinally along the inner profile.

It is allowed for adjusting the degree of inclination of the two sides of the guiding sets, in case there are irregularities on the surface of the wall on which the assembly is to be installed, by means of a construction arrangement that is relatively easy to carry out and install.

### OBJECT OF THE INVENTION

The present application is for the registration of a construction assembly for installing a roller blind or the like.

More specifically the invention proposes the development of a construction assembly for installing a roller blind or the like comprising two parallel guiding sets spaced at a predetermined distance, between which a roller blind can be slid in a guided manner, being joined at the top by the roller blind in an embodiment provided with a caisson which is provided to house the roller blind when it is rolled up.

### FIELD AND BACKGROUND OF THE INVENTION

There is a wide variety of roller blinds, shades and the like on the market which differ in several aspects, among which are those related to their structural configuration.

Construction assemblies for installing a roller blind or similar comprising two parallel guiding sets spaced at a predetermined distance, between which a roller blind can be slid in a guided manner are well known. Each of the sets comprises an elongated profile arranged vertically where it moves in a guided manner, this profile being fastened through conventional fastening means on a wall or vertical surface.

It has been observed, however, that in practice the inside walls of rooms, such as interior rooms, etc., may have imperfections meaning that they are not straight or leveled, etc., thus causing misalignment of the two guiding sets and consequently bringing about a malfunction of the blinds during the raising/lowering action or it may involve having to modify or carry out adjustments in the profiles of the lateral guides in order to adjust to the imperfections of the wall. This implies requiring longer time for the assembly operation of the blind construction assembly.

In addition, the applicant is currently unaware of the existence of an invention having all the characteristics described herein.

### SUMMARY OF THE INVENTION

The present invention was developed with the aim of providing a construction assembly that constitutes a novelty within the field of application, and solves the disadvantages mentioned above while also contributing other additional advantages, which will become evident from the description provided below.

It is therefore an object of the present invention to provide a construction assembly for installing a roller blind or the like of the type comprising two parallel guiding sets spaced at a predetermined distance, between which a roller blind can be slid in a guided manner, the two guiding sets being for example, joined at the top by a caisson which is provided to house the roller blind when it is rolled up. In particular, the invention is characterized in that each of the guiding sets comprises the following parts:
an internally hollow outer profile that can be fastened to a vertical surface,
an internally hollow inner profile that is arranged in the interior of the outer profile, the inner profile having dimensions such that it is insertable into a housing defined by the outer profile by means of a snap fit.
a retaining element configured to retain a longitudinal edge of the roller blind arranged longitudinally along the inner profile.

Due to these characteristics, it is possible to adjust the degree of inclination of the two sides of the guiding sets, in case there are irregularities on the surface of the wall on which the assembly is to be installed, by means of a construction arrangement that is relatively easy to carry out and install. Consequently, a malfunction of the roller blind during raising/lowering operations as well as having to install different profiles for each of the guiding sets is avoided. In other words, there is a possibility of having relative motion between the outer profile and the inner profile, this motion being angular and/or translational.

According to another aspect of the invention, the assembly comprises resilient means acting between the inner profile and the retaining element, such that they hold the retaining element in position inside the inner profile.

Preferably, the resilient means comprise at least one spring element provided with a rigid section and a resilient tongue section, the spring element being located in a cavity defined by an extension protruding from the inner face of the inner profile towards the interior.

More preferably, the resilient means comprise at least two spring elements, as described above, which are housed in two different cavities of the inner profile. While it is also worth mentioning that in each of the two cavities a plurality of spring elements may be arranged in a distanced manner and longitudinally along the length of the corresponding cavity. The number of spring elements will depend on the length of the roller blind.

Preferably, the outer profile and the inner profile are each substantially “U” shaped.

Advantageously, the roller blind comprises a longitudinally arranged toothed area at the insertable edge of the retaining element.

According to another aspect of the invention, the construction assembly may include joining means in order to firmly attach the outer profile and the inner profile. Preferably, said joining means consist of holes made in the outer profile and the inner profile provided for inserting screw elements.

### BRIEF DESCRIPTION OF THE SEVERAL VIEWS OF THE DRAWINGS

Other characteristics and advantages of the construction assembly, object of the present invention, will become clear in light of the description of a preferred, though non-exclusive, embodiment, which, by way of a non-limiting example, is illustrated in the accompanying drawings, wherein:

FIG. 1 is a detailed perspective view of one of the guiding sets and partly a section of the roller blind;

FIG. 2 is an exploded partial and detailed perspective view of the guiding set shown in FIG. 1;

FIG. 3 is a detailed expanded view of the upper part of the guiding set;

FIG. 4 is a detailed perspective view of a spring element;

FIG. 5 is an elevation view of the guiding set shown in the previous figures;

FIG. 6 is a schematic view of a guiding set;

FIG. 7 is a cross-sectional partial plan view of a guiding set along the A-A-line;

FIG. 8 is a perspective view of an additional embodiment of a set provided with two roller blinds, each one connected to a guiding set;

FIG. 9 is a exploded perspective view of set represented in the FIG. 9; and

FIG. 10 is a perspective view of detail corresponding to region where two rollers are mounted, supporting each roller a roller blind.

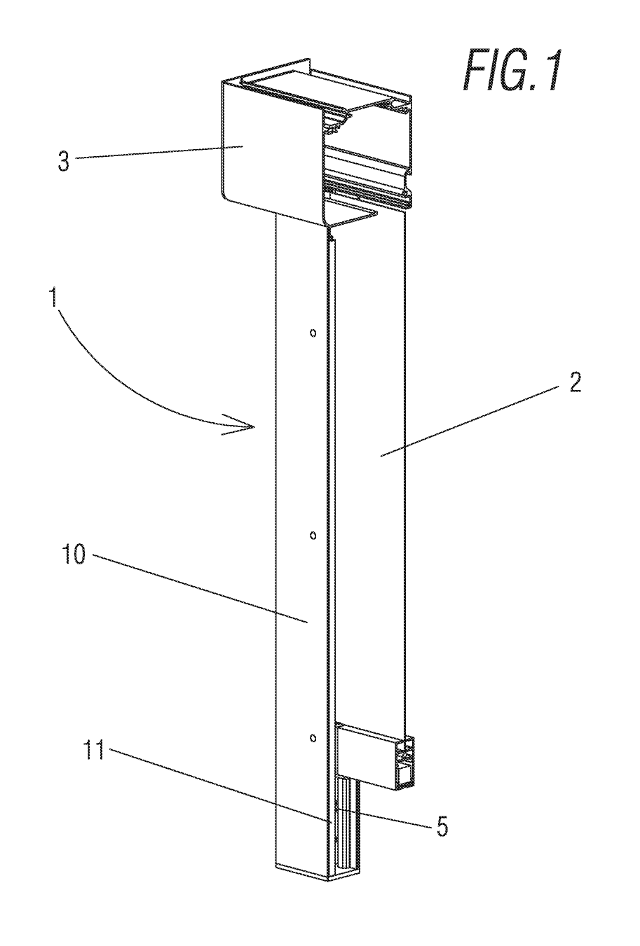

### DESCRIPTION OF SPECIFIC EMBODIMENTS OF THE INVENTION

In view of the aforementioned figures and, in accordance with the numbering adopted, an example of a preferred embodiment of the invention can be observed therein, which comprises the parts and elements indicated and described in detail below.

A specific embodiment of the construction assembly for installing a roller blind or the like comprises two guiding sets, generally indicated with reference (1), which run parallel and spaced apart by a predetermined distance, between which a roller blind (2) can be slid in a guided manner, the two guiding sets (1) being joined at the top by a horizontal caisson (3) provided to house the roller blind (2) therein when it is rolled up. It should be noted that only one of the guiding sets (1) is shown in the figures since both sets are alike, so that the person skilled in the art will understand the composition of the construction assembly.

At a more detailed level, each of the guiding sets (1) comprises an internally hollow outer profile (10) that can be fastened to a vertical surface and an internally hollow inner profile (11) arranged on the interior of the outer surface (10), the inner surface (11) having dimensions such that it is insertable into a housing defined by the outer profile (10) by means of a snap fit. Thus, a small amount of motion is possible between both profiles (10, 11), moving the inner profile (11) in translation and/or in angle with relation to the outer profile (10) in order to adjust to the irregularities in the leveling of the wall (not shown) on which the assembly is to be mounted.

The outer profile (10) and the inner profile (11) are each substantially “U” shaped.

Additionally, a retaining element (4) is provided for retaining a longitudinal edge of the roller blind (2), the retaining element (4) having the shape of an elongated profile that is longitudinally arranged along the inner profile (11).

The construction assembly comprises resilient means (detailed below) acting between the inner profile (11) and the retaining element, such that they hold the retaining element in position inside the inner profile (11).

Referring specifically to the resilient means, they comprise spring elements (5) having an internally hollow rigid section (5) and a resilient tongue section (51), the spring element (5) being located in a cavity (110) defined by an extension (111) protruding from the inner face of the inner profile (11) towards the interior.

Preferably, it comprises a plurality of spring elements (5) spaced from each other, being housed in the two cavities (110) in two sides of the inner profile (11).

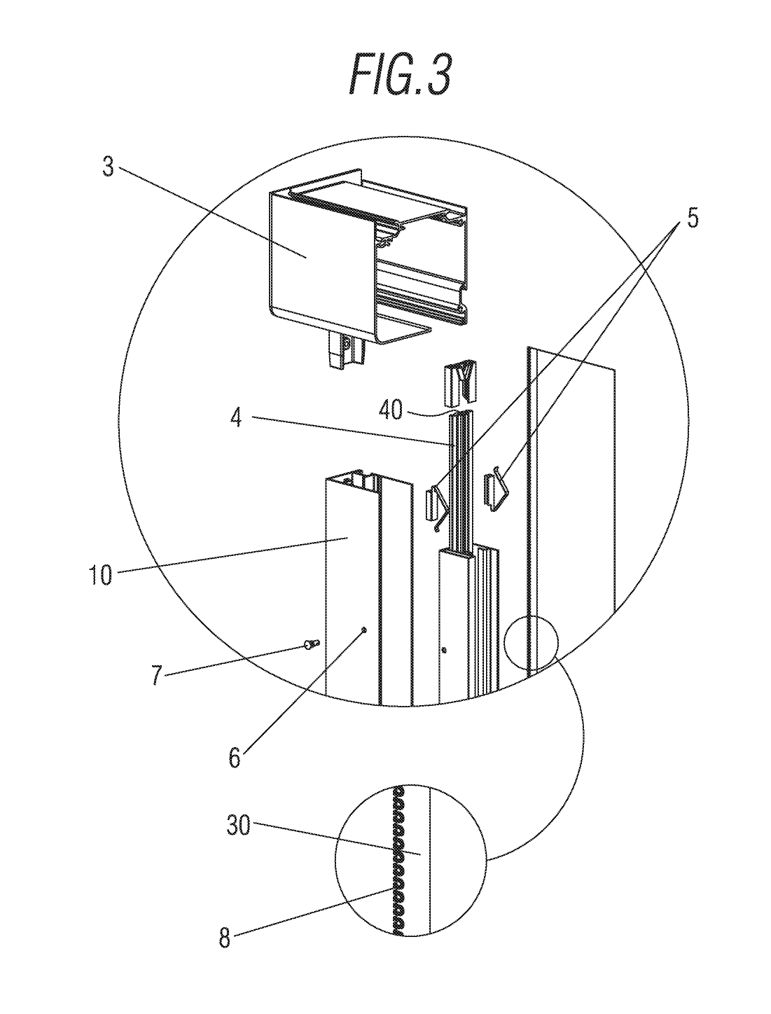

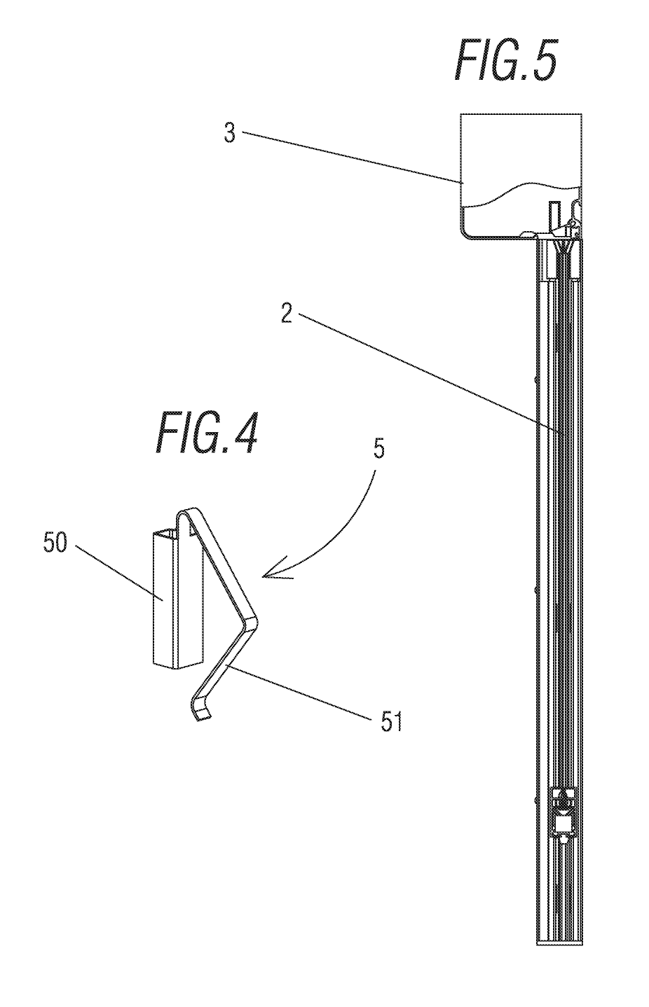

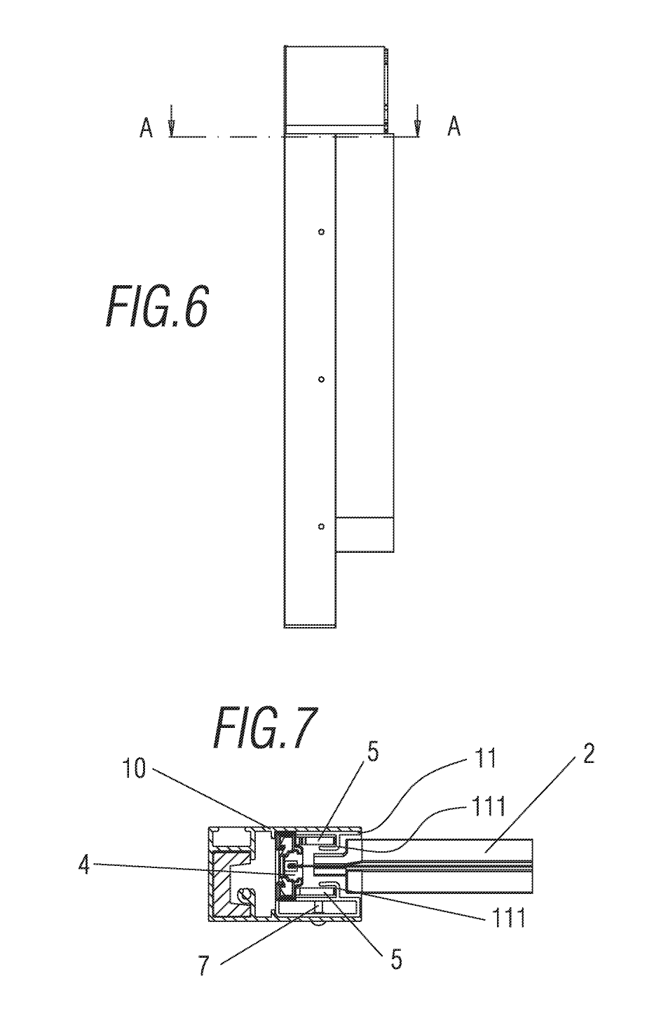

As shown in detail in FIG. 3, the roller blind (2) comprises a longitudinally arranged toothed area formed by a plurality of teeth or inserts (8) at each of its two opposing edges, that is, the edge (30) that is insertable into a longitudinal slit (40) formed in the retaining element (4).

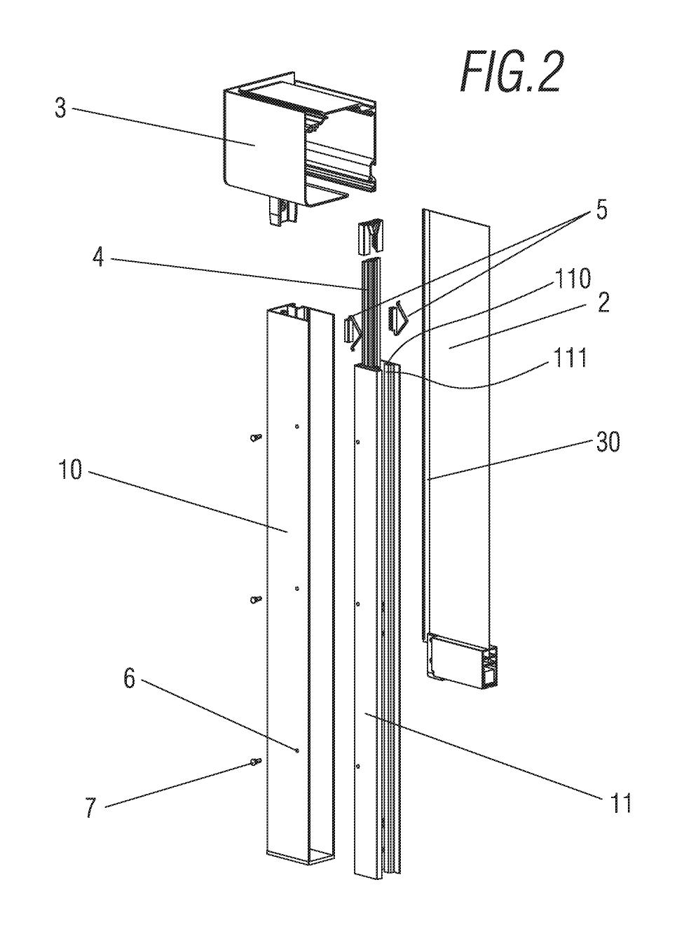

In addition, joining means are provided in order to firmly attach the outer profile and the inner profile. Such joining means consist of through holes (6) made in the outer profile and the inner profile provided for inserting the screw elements (7), as shown in FIGS. 2 and 3. Alternatively, the screw elements may be replaced by a mechanical link (not shown) such as, for example, a rivet.

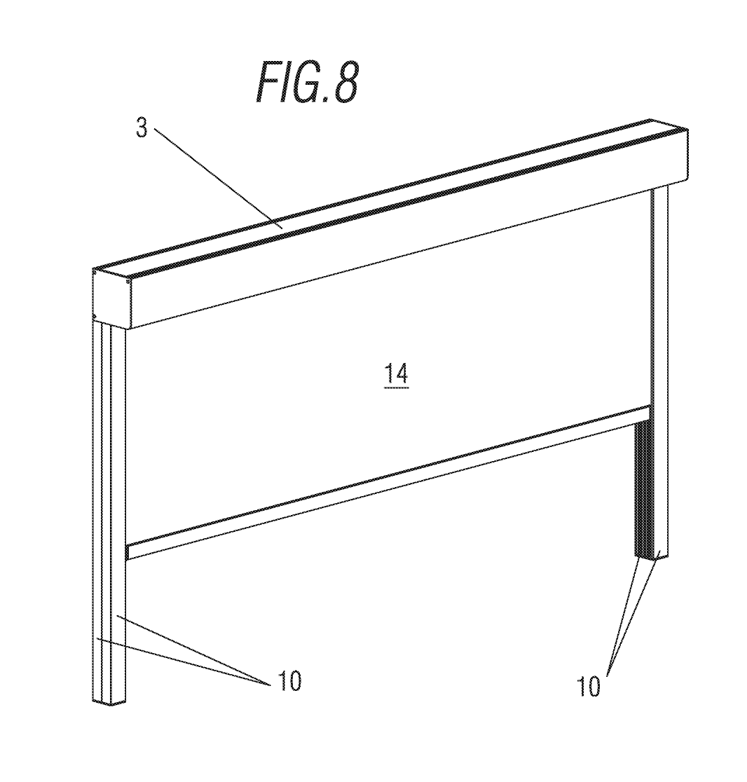

In the FIGS. 8 to 10, a second embodiment of the invention is shown. The common parts have the same numeral references than above explained exemplary embodiment.

In said second embodiment, the construction assembly for installing a roller blind or the like comprising two parallel guiding sets spaced at a predetermined distance, between which a first roller blind (13) can be slid in a guided manner, and two additional parallel guiding sets spaced at a predetermined distance, between which a second roller blind (14) can be slid in a guided manner, each one of first and second roller (13, 14) blind being arranged in the upper part of the two guiding sets (1).

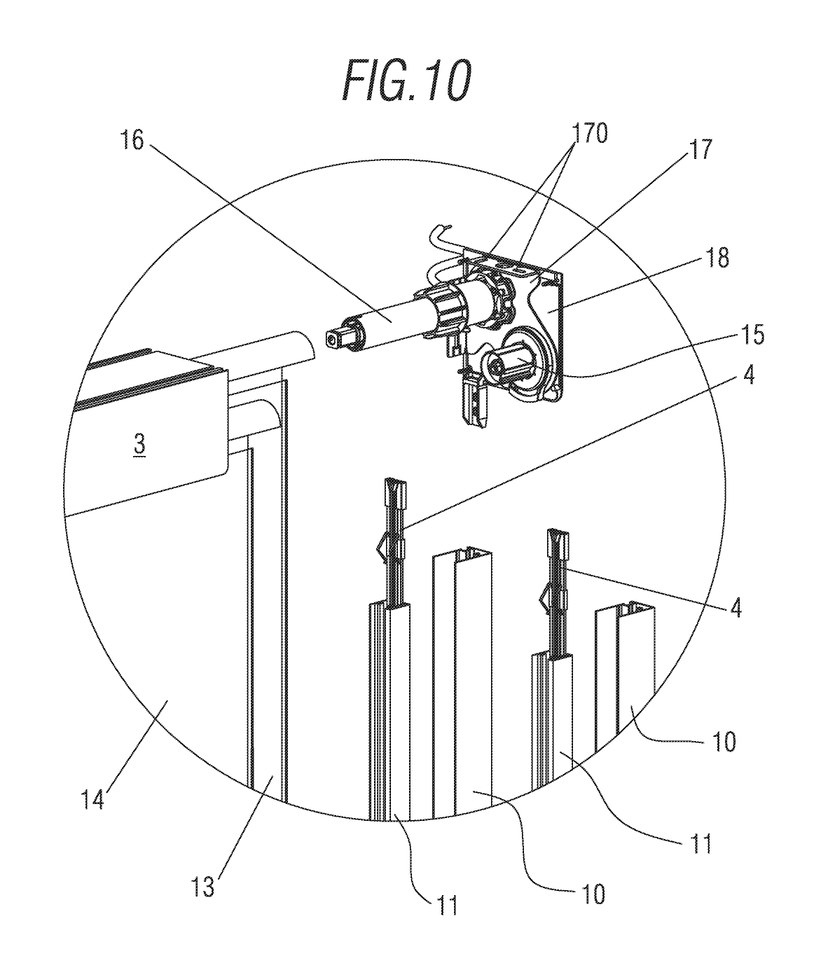

The first and the second roller blinds (13, 14) are mounted on independent rollers (15, 16) arranged apart, in this case, each one housed inside a caisson (3) so that first and the second roller blinds (13, 14) are disposed on parallel way. In particular, each end of each one of the rollers (15, 16) is mounted in a metal plate (17) placed on a lateral wall (18) of caisson (3), as shown in FIG. 10. This metal plate (17) is fixed, for example, on the roof by means of conventional fixing means which passes through of holes (170) bored in the metal plate (17). For reasons of clarity, one of two metal plates (17) is represented.

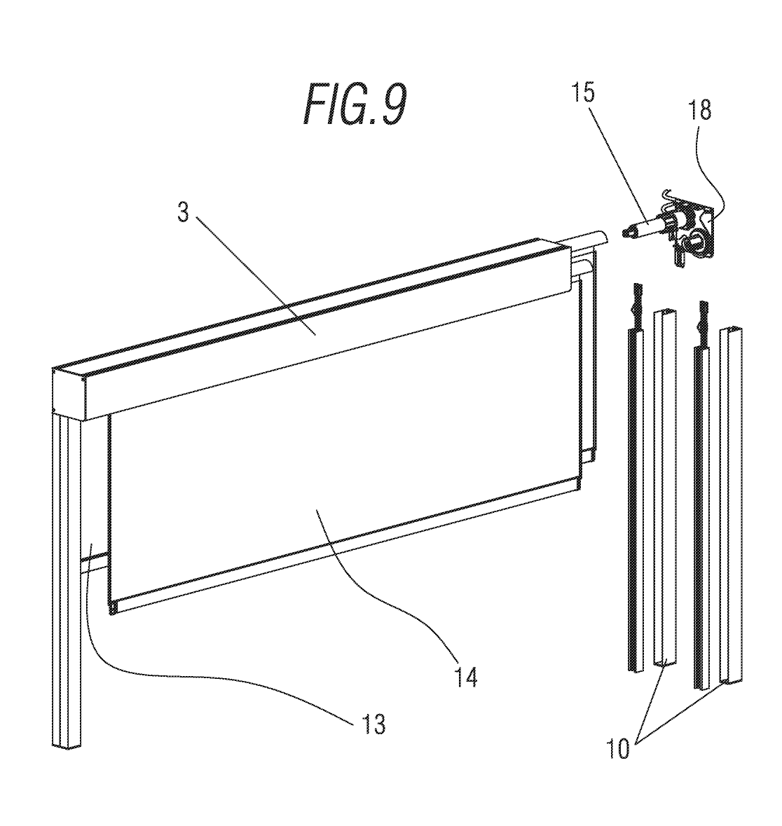

With respect to each one of guiding sets (1) has the same technical features as guiding sets (1) disclosed in the above embodiment, as shown in FIGS. 9 and 10. For the reason, the guiding sets (1) will not disclosed with more detail.

In an alternative embodiment, it is possible that outer profile (10) from each one of two roller blinds (13, 14), placed on the same side, can be formed in a single oversized profile provided with two grooved portions which extend longitudinally.

In a not shown embodiment of the invention, the caisson can be engaged to several guiding sets by means of a known mechanical fixing system on a wall.

The details, shapes, dimensions and other accessory elements used to manufacture the construction assembly of the invention may be suitably substituted for others which do not diverge from the scope defined by the claims included below.

What is claimed is:

1. A construction assembly for installing a roller blind or the like comprising two parallel guiding sets spaced at a predetermined distance, between which at the least a roller blind can be slid in a guided manner, the at the least roller blind being arranged in the upper part of the two guiding sets, and in which each of the guiding sets comprises:
an internally hollow outer profile that can be fastened to a vertical surface,
an internally hollow inner profile that is arranged in the interior of the outer profile, the inner profile having dimensions such that it is insertable into a housing defined by the outer profile by means of a snap fit,
a retaining element configured to retain a longitudinal edge of the roller blind arranged longitudinally along the inner profile.

2. The construction assembly for installing a roller blind or the like according to claim 1, wherein it comprises resilient means acting between the inner profile and the retaining element, such that it holds the retaining element in position inside the inner profile.

3. The construction assembly for installing a roller blind or the like according to claim 2, wherein the resilient means comprise at least one spring element provided with a rigid section and a resilient tongue section, the spring element being located in a cavity defined by an extension protruding from the inner face of the inner profile towards the interior.

4. The construction assembly for installing a roller blind or the like according to claim 2 wherein it comprises at least two spring elements housed in two different cavities of the inner profile.

5. The construction assembly for installing a roller blind or the like according to claim 1, wherein the outer profile and the inner profile are each substantially “U” shaped.

6. The construction assembly for installing a roller blind or the like according to claim 1, wherein the roller blind comprises a longitudinally arranged toothed area at the insertable edge of the retaining element.

7. The construction assembly for installing a roller blind or the like according to claim 1, wherein it includes joining means for firmly attaching the outer profile and the inner profile.

8. The construction assembly for installing a roller blind or the like according to claim 7, wherein said joining means consist of holes made in the outer profile and the inner profile provided for inserting screw elements or the like.

9. The construction assembly for installing a roller blind or the like according to claim 1, wherein the two guiding sets are joined at the top by a caisson provided for housing the roller blind when it is rolled up.

10. A construction assembly for installing a roller blind or the like comprising two parallel guiding sets spaced at a predetermined distance, between which a first roller blind can be slid in a guided manner, and two additional parallel guiding sets spaced at a predetermined distance, between which a second roller blind can be slid in a guided manner, each one of first and second roller blind being arranged in the upper part of the two guiding sets, wherein the first and second roller blind are extensible and in a parallel way between to each other, which each of the guiding sets comprises:
an internally hollow outer profile that can be fastened to a vertical surface,
an internally hollow inner profile that is arranged in the interior of the outer profile, the inner profile having dimensions such that it is insertable into a housing defined by the outer profile by means of a snap fit,
a retaining element configured to retain a longitudinal edge of the roller blind arranged longitudinally along the inner profile.

11. The construction assembly for installing a roller blind or the like according to claim 10, wherein the first and the second roller blinds are mounted on independent rollers arranged apart, each one housed inside a caisson.

12. The construction assembly for installing a roller blind or the like according to claim 11, wherein each end of each one of the rollers is mounted in a plate, being placed said plate inside of a horizontal caisson.

13. The construction assembly for installing a roller blind or the like according to claim 10, wherein it comprises resilient means acting between the inner profile and the retaining element, such that it holds the retaining element in position inside the inner profile.

14. The construction assembly for installing a roller blind or the like according to claim 13, wherein the resilient means comprise at least one spring element provided with a rigid section and a resilient tongue section, the spring element being located in a cavity defined by an extension protruding from the inner face of the inner profile towards the interior.

15. The construction assembly for installing a roller blind or the like according to claim 13, wherein it comprises at least two spring elements housed in two different cavities of the inner profile.

16. The construction assembly for installing a roller blind or the like according to claim 10, wherein the outer profile and the inner profile are each substantially “U” shaped.

17. The construction assembly for installing a roller blind or the like according to claim 10, wherein the roller blind comprises a longitudinally arranged toothed area at the insertable edge of the retaining element.

18. The construction assembly for installing a roller blind or the like according to claim 10, wherein it includes joining means for firmly attaching the outer profile and the inner profile.

19. The construction assembly for installing a roller blind or the like according to claim 18, wherein said joining means consist of holes made in the outer profile and the inner profile provided for inserting screw elements or the like.
